(19) United States
(12) Patent Application Publication
(10) Pub. No.: US 2010/0164319 A1
(43) Pub. Date: Jul. 1, 2010

(54) METHOD FOR MANUFACTURING A WINDING COIL FOR AN ELECTRICAL MACHINE AND A WINDING FOR AN ELECTRICAL MACHINE

(75) Inventors: Heikki Metsberg, Helsinki (FI); Heikki Sinivuori, Vihti (FI); Jari Jäppinen, Helsinki (FI); Leo Hämäläinen, Helsinki (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 12/529,672

(22) PCT Filed: Mar. 3, 2008
(86) PCT No.: PCT/FI2008/000036

§ 371 Date: Jan. 8, 2010

(30) Foreign Application Priority Data
Mar. 2, 2007 (FI) 20070185

(51) Int. Cl. H02K 3/12; H02K 15/04

(52) U.S. Cl. 310/208; 29/596

(57) ABSTRACT

The object of the invention is a method for manufacturing a winding coil for an electrical machine, as well as the corresponding winding. The electrical machine comprises a stator sheet pack in which slots are arranged at the edge of the inner circumference of the sheet pack for fitting the winding coils. In the method, a winding coil is made of flat wire so that one coil turn (42, 44) goes around a tooth (2) between adjacent slots. According to the invention, the coil turns (42, 44) are manufactured so that one coil end (46) is bent substantially close to the edge (50) of the sheet pack, and a second coil end (60) is bent at a distance from the edge (50) of the sheet pack. The first and second coil end bent at different positions are fitted to the slot one on top of the other around the tooth (2).

The object of the invention is a method for manufacturing a winding coil for an electrical machine according to the preamble part of claim 1, and a winding for an electrical machine according to the preamble part of claim 7.

The stator winding of an electrical machine is usually fitted into stator slots formed in the stator's magnetic sheet pack. A certain type of electrical machine is a so-called concentrated winding machine, particularly an electrical machine with a small slot factor, in which the stator winding is manufactured so that each coil turn or coil in the winding is around one tooth of the stator. In this case one slot holds the coil sides of two adjacent coils. The coils may also be wound around every other tooth, making one coil fill the entire slot. In these electrical machines with a small slot factor, the slot factor is q<1, the slot factor being defined as q=Q/(m*2*p), in which Q refers to the number of slots, m to the number of phases and p to the number of pole pairs in the machine.

The stator winding is dimensioned to produce sufficient magnetomotive force that is determined as the product of the number of conductor turns in the winding N and the current flowing in the winding I. For example, in machines with a small slot factor and a substantially high number of slots, the slot available for each winding is relatively narrow. A prior art winding coil is made of flat wire such as flat bar copper, the cross-section of which is rectangular and which is insulated before the manufacture of the coil. With such a conductor, the slot filling factor is high, and when a standard conductor is used, the winding is economical to manufacture.

When the electrical machine is operated, current flowing in the conductor creates heat that must be cooled in order to ensure efficient operation of the electrical machine. The coil ends can be cooled using air circulated through them, for example, that is blown using a fan fitted to the shaft of the electrical machine or a separate blower. However, the heat generated by the winding's coil sides in the slots must be conducted to the surrounding iron, or cooling channels with circulating coolant have to be arranged beside the coil sides. When the dimensioning of the electrical machine makes it impossible to install separate cooling channels in the slots, it is preferred to use a winding in which the heat generated by conductors in the coil sides is transferred in the best possible way to the electrical machine's iron parts surrounding the winding. In other words, the coil shall be manufactured so that the coil conductor is in contact with the teeth at the edge of the slot to the largest extent possible. When a single-layer coil is wound of a flat wire with rectangular cross-section and when the straight edge of the section coil is in contact with the tooth, the heat generated in the conductor is directly transferred to the tooth and from there to the body section of the electrical machine.

Naturally the dimensioning of an electrical machine is aimed at the best possible efficiency and an economical manufacturing method. In some cases such as electrical machines with a small slot factor and concentrated winding, the space reserved for the winding coil in the slots is limited when the number of slots is high. When the coil is made of said flat wire so that the slot filling factor is as high as possible, the coil's conductor layers are in contact with each other in the depthwise direction of the slot, and the completed coil fills the entire slot in the depthwise direction. However, a conductor made of flat wire becomes substantially upset close to the coil ends at the inner edge of the bend. At the end of the electrical machine's slot and at the coil end areas, the total thickness of the coil in the radial direction increases, due to which the coil tends to come out of the slot in the radial direction close to the end of the electrical machine or at least increases the pressure on the slot wedge, which will lead to failure of the wedge over time.

The objective of the invention is to develop a new and economical solution for forming a winding coil for an electrical machine out of continuous winding wire and eliminating the problem described above. In order to achieve this, the method for manufacturing a winding coil for an electrical machine according to the invention is characterised by the features specified in the characteristics section of claim 1. Correspondingly, the winding for an electrical machine according to the invention is characterised by the features specified in the characteristics section of claim 7. Certain other embodiments of the invention are characterised by the features of the dependent claims.

When coils are manufactured according to the invention, whereby the conductor bends are placed alternately closer to and farther from the edge of the stator slot, the upset bends of the overlapping conductors are not at the same positions, which keeps the conductors in close contact with each other for the entire length of the slot. This maximises the slot filling factor and the ampere-turn number of the coil.

When a conductor is bent, the conductor insulation is deteriorated due to upsetting to the conductor. Correspondingly, on the outer edge of the bend, the insulator stretches and, for example, the overlapping part of braid insulation is reduced. When the invention is applied, the bent points do not contact each other. As a consequence, the voltage strength of the turn insulation of the coil does not deteriorate at the coil ends as the bent areas of the conductors do not contact each other.

Because windings manufactured using the method according to the invention and located at the coil ends are not in contact with each other, this increases the efficiency of cooling as the air flow is in contact with the coil end of each layer.

In the following, the invention will be described in detail by referring to the enclosed drawings, where

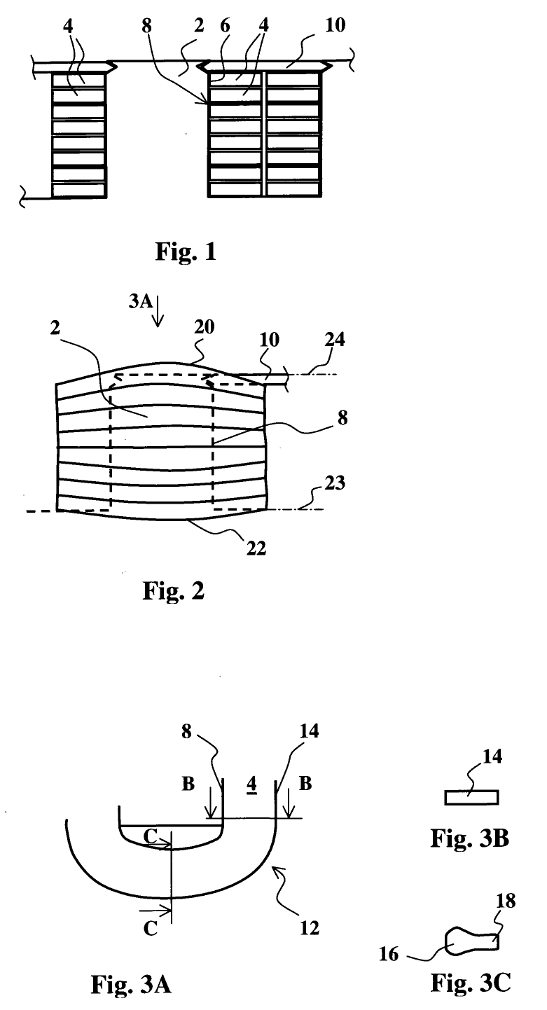

FIG. 1 illustrates a part of a winding according to the invention,

FIG. 2 illustrates a prior art solution,

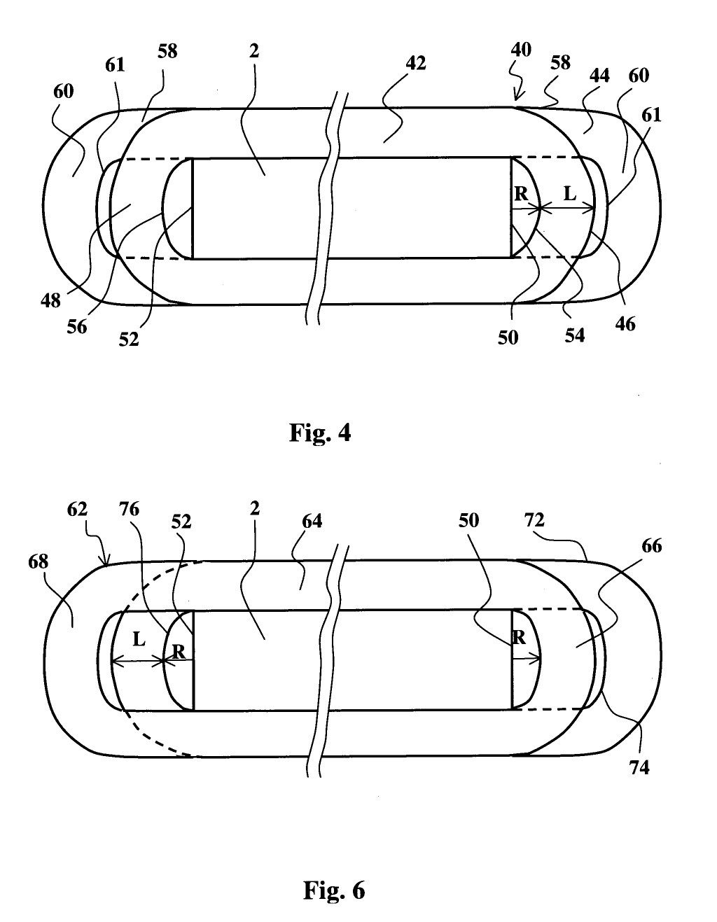

FIG. 3A illustrates a part of the winding from the direction of the air gap,

FIG. 3B illustrates the section B-B in FIG. 3A,

FIG. 3C illustrates the section C-C in FIG. 3A,

FIG. 4 illustrates a winding according to the invention,

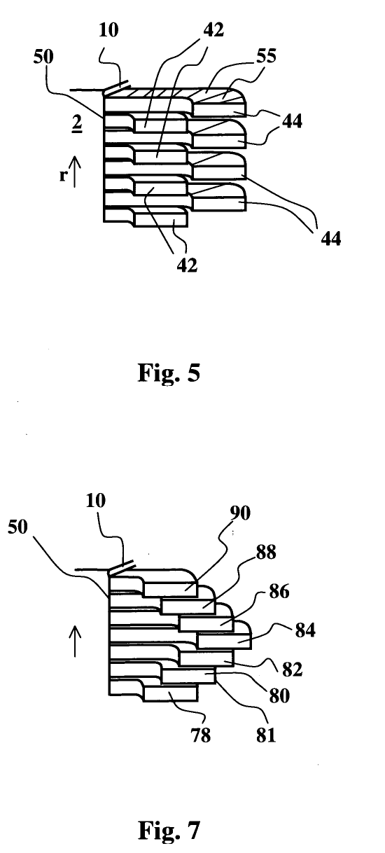

FIG. 5 illustrates a coil end arrangement according to the invention,

FIG. 6 illustrates another winding according to the invention, and

FIG. 7 illustrates another coil end arrangement according to the invention.

FIG. 1 illustrates a cross-section of a stator tooth 2 in an electrical machine with coil conductors 4 made of flat copper wire wound around the tooth. The cross-section of the conductors is flat and rectangular, putting one of the short sides 6 of the conductor into contact with the side wall 8 of the tooth 2. The conductors 4 are insulated with conductor insulation using a known method and connected from one coil end directly or through a bus bar to the external connectors of the electrical machine (not illustrated) using a known method. The windings going around the adjacent teeth share the slot 4 with the conductors. After fitting the windings in place, the stator slot is blocked with a slot wedge 10.

When flat copper wire according to FIG. 1 is wound around the tooth by bending the flat copper wire around its narrow side, the inner edge of the conductor becomes upset. This is illustrated in FIGS. 2, 3A, 3B and 3C. FIG. 2 illustrates the coil end viewed from the end of the stator with regard to one tooth and the winding coil wound around it. FIG. 3a illustrates the coil end 12 viewed from the air gap of the electrical machine. At the slot, in other words at the coil side 14, the flat copper wire is rectangular as illustrated in FIG. 3b, which is the section B-B in FIG. 3A. FIG. 3C illustrates the cross section C-C of the flat copper wire 4 at the coil end, at the middle of the tooth 2. Due to bending the flat copper wire, its inner edge 16 is upset and is clearly thicker than the cross section on the coil side illustrated in FIG. 3b or the outer edge 18 of the flat copper wire at the coil end. As a consequence of the upsetting illustrated in FIG. 3c and the thickening of the flat copper wire in the coil end area, the space required by the winding coil increases in the depth wise direction of the tooth—that is, the radial direction of the electrical machine. As illustrated in FIG. 2, the inner edge 20 of the coil end, which is the edge facing the rotor, tends to extend outside the line defined by the top edge 24 of the slot, and correspondingly, the outer edge 22 tends to extend outside the line 23 defined by the bottom edge of the slot. At the same time, they push the slot wedge 10 located between the teeth outwards. It should be understood that the deformation in FIG. 3c and FIG. 2 is exaggerated to illustrate the matter but in reality the thickening caused by upsetting is smaller.

FIG. 4 illustrates an embodiment of the present invention in which the winding coil 40 formed around one stator tooth 2 is viewed from the direction of the air gap of the electrical machine. The figure only illustrates the two coil turns 42 and 44 closest to the air gap but naturally it should be understood that there can be more coil turns as shown in the example of FIG. 1. The winding coil is wound of continuous winding wire made of insulated flat copper wire. The coil turn 42 comprising one conductor of flat copper wire is wound around the tooth 2 so that in the areas of both coil ends 46 and 48, the conductor is bent around its narrow side substantially close to the stator tooth end 50 and, correspondingly, 52. The flat copper wire is coated with conductor insulation as mentioned above in the description of prior art. At the middle of the bending point, a dimension approximately corresponding to the bending radius R of the conductor remains between the inner edge 54 of the conductor and the end of the tooth 50 and, correspondingly, between the other inner edge 56 and the end of the tooth 52. The second coil turn 44 below the top coil turn 42 is bent so that its straight parts extend clearly outside the tooth 2, which results in a coil end constituting a straight part 58 and a bent part 60 at both ends of the tooth 2. The bending radius of the coil turn 44 corresponds to the bending radius R of the first coil turn 42 but at both ends of the tooth, the inner surface 61 of the coil turn 44 is at an approximate distance of R+L from the tooth ends 50 and 52, L referring to the width of the flat copper wire. FIG. 5 illustrates a partial cross-section of the successive coil turns 42 and 44 in the coil end area. The upset area at the coil ends of overlapping coils is at different positions in the radial direction r of the electrical machine, and they are not in contact with the adjacent coil turn. The coils are coated with turn insulation 55 as illustrated at coil turn 42 in FIG. 5. As the bent sections of the coil ends are at different positions in successive coil turns, there is no risk of reduced voltage strength between successive coil turns.

The coil turn in the embodiment of the invention illustrated in FIGS. 4 and 5 comprises two straight sides that are fitted in the slots, as well as two curved parts between the straight sides that are outside the sheet pack and form the coil ends. The midpoint of the sheet pack in the axial direction is the electromagnetic centre of an electrical machine. This centre must also be considered as the centreline of the electrical machine's windings in the axial direction of the machine. The first end of the lowermost coil turn, which is the one at the bottom of the slot, extends to the minimum distance from the centreline, in other words the curved part of the coil end starts immediately outside the edge of the sheet pack, and the distance between the first coil turn and the centreline is half the length of the sheet pack plus the dimension required by the coil end. The distance between the second end of the lowermost coil turn and the centreline is the same as that of the first end, in other words one half of the sheet pack length, plus the length required for bending the coil end. The first end of the second-lowest coil turn extends straight from the centreline farther than the sheet pack edge so that the end of the second coil is bent outside the end of the first coil in the axial direction of the machine. Correspondingly, the second end of the second-lowest coil turn extends equally far from the centreline, in other words, the bending of the coil end starts outside the sheet pack edge and the first coil turn. In the third-lowest coil turn and subsequent odd-numbered coil turns, the coil end bends and coil end distances from the centreline correspond to the bends and distances of the first coil turn. Correspondingly, the fourth-lowest coil turn and subsequently the even-numbered coil turns correspond to the second-lowest coil turn in terms of bends and distances.

FIG. 6 illustrates another embodiment of the invention. In this case, the first coil turn 62 is bent so that at the first end 50 of the tooth 2, the inner surface 64 of the coil is substantially close to the tooth end 50—that is, at a distance approximately corresponding to the bending radius R at the middle of the coil end 66. However, the opposite coil end 68 is farther away from the tooth end 52, or at a distance approximately determined by the bending radius R and the width of the flat copper wire L. The second coil turn 72 is fitted around the tooth 2 so that the inner surface 74 of the coil end is at an approximate distance of R+L from the first end 50 of the tooth. Correspondingly, the inner surface 76 of the second coil end of the coil turn 72 is located at a distance from the second end 52 of the tooth approximately corresponding to the bending radius R. Thus, at the first end 50 of the tooth, the coil turns 62 and 72 alternate as illustrated in FIG. 5. However, at the other end of the tooth, the coil turns are in reversed order, which provides the same effect, and upsetting of the flat copper wire does not impose any forces on the slot wedge or the adjacent coil ends.

FIGS. 4-6 illustrate the coil turns installed around a tooth 2 of an electrical machine. According to the invention, the coils can be wound directly around the tooth. Alternatively the winding coils can be manufactured advantageously in advance around a winding form. This makes it possible to advantageously bend coils of different lengths into the correct shape in advance, which facilitates and expedites manufacture.

FIG. 7 illustrates the coil end section of an embodiment of the invention in which the coil ends are partially overlapped. The coil end 78 of the lowermost coil turn is bent immediately outside the edge 50 of the sheet pack. The corresponding coil end 80 of the second-lowest coil turn is bent slightly farther from the edge of the sheet pack so that the coil ends are slightly overlapping in the radial direction of the machine. However, the upset section illustrated in FIG. 3c is not at the same position in the successive coil ends. Therefore the weakest points of the coil braid insulation that has deteriorated due to bending are not overlapping but slightly shifted in the axial direction of the machine. Correspondingly, the next coil turns, the third one 82 and the fourth one 84 are again bent slightly farther away from the centreline than the previous one. The three topmost coil turns 86, 88 and 90 are bent gradually closer to the sheet pack edge 50 than the fourth coil turn 84. Thus the lowermost 78 and the topmost 90 turn are bent at the same position.

The bending radiuses of the coil ends may vary in many ways within the scope of the inventive idea. For example, the bends in the coil ends may alternate similarly to the two lowermost coil turns 78 and 80 in FIG. 7, in which case the farthermost point of the coil end in the axial direction of the machine corresponds to the outermost point of the second-lowest coil end 81 in FIG. 7. Various other types of gradation and interleaving can also be implemented in accordance with the requirements of the application at hand.

The coil ends will preferably be cooled well when cooling air has unobstructed passage into each conductor layer. In the embodiment illustrated in FIGS. 4 to 6, there is an air gap between successive coil turns in the radial direction of the machine, allowing air to flow between them and cool the outer and inner surface of every conductor in the coil end area.

In the above, the invention has been described with the help of certain embodiments. However, the description should not be considered as limiting the scope of patent protection; the embodiments of the invention may vary within the scope of the following claims.

1. A method for manufacturing a winding coil for an electrical machine, said electrical machine including at least a stator sheet pack with slots arranged at an edge of an inner circumference of the sheet pack for fitting winding coils, which method comprises:
winding several coil turns of continuous flat wire so that a coil turn goes around a tooth between adjacent slots;
and bending the flat wire at a section external to the sheet pack to form the coil ends, wherein the step of winding includes:
manufacturing at least a first coil turn, at least one coil end of which is bent substantially close to an edge of the tooth;
manufacturing at least a second coil turn, at least one coil end of which is bent at a distance from the edge of the tooth;
and fitting the first and second coil turns one on top of the other to form the coil turn in the slot around the tooth.

2. A method according to claim 1, wherein the flat wire has a substantially rectangular cross-section with a first side narrower than a second side, and the section wire is bent at the coil end around the first side of the section wire.

3. A method according to claim 1, wherein the first coil turn is bent at both of its ends substantially close to the edge, and the second coil turn is bent at a distance from ends of the tooth.

4. A method according to claim 1, wherein the coil turns are pre-bent and subsequently installed in the slots of the electrical machine.

5. A method according to claim 1, wherein the second coil end of the first coil turn is bent at a distance from a second edge of the tooth, and the second coil turn is bent substantially close to the second end of the tooth.

6. A method according to claim 1, wherein overlapping coil ends in a radial direction (r) of the electrical machine are interleaved so that they are bent at different positions in an axial direction of the electrical machine.

7. A winding for an electrical machine, said electrical machine comprising:
a stator formed of ferromagnetic sheets, the sheets being stacked into a sheet pack in an axial direction of the electrical machine, slots opening towards an air gap of the machine are formed in the sheet pack and the stator winding of the electrical machine is fitted into the slots so that a coil turn is closed around a stator tooth between two adjacent slots, several coil turns being arranged around each tooth, wherein the coil turn is made of flat wire having a flat cross-section so that a narrower edge of the flat wire is against the wall of the slot, the flat wire is bent at the end of the sheet pack around its narrower side so that in a coil end area, the flat wire remains in substantially a same position as in the slot area and at both ends of the stator, adjacent flat wires are bent so that their curved parts are at least partially at different positions.

8. An electrical machine according to claim 7, wherein the coil turns are alternately shorter and longer in the axial direction of the electrical machine.

9. An electrical machine according to claim 7, wherein the coil turns are substantially equal in length in the axial direction of the machine and that the coil turns are alternately interleaved in the first and second end in the axial direction of the machine.

10. An electrical machine according to claim 7, wherein the coil turns are bent so that the coil ends are alternately interleaved.

11. An electrical machine according to claim 7, wherein the flat wires are insulated before a coil turn is formed.

12. An electrical machine according to claim 7, wherein the flat wires are insulated with braid insulation.

13. An electrical machine according to claim 7, wherein the successive coil turns are substantially in contact with each other.
